(19) United States
(12) Patent Application Publication
(10) Pub. No.: US 2006/0019808 A1
(43) Pub. Date: Jan. 26, 2006

(54) Variable crown roll

(75) Inventors: Peter Svenka, Grefrath (DE); Bernard Brendel, Grefrath (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Eduard Kusters Maschinenfabrik GMBH & CO. KG, Krefeld (DE)

(21) Appl. No.: 10/531,528

(22) PCT Filed: Oct. 15, 2003
(86) PCT No.: PCT/EP03/11390

§ 371 Date: Jun. 9, 2005

(30) Foreign Application Priority Data
Oct. 24, 2002 (DE) 102 49 796.6

(51) Int. Cl. F16C 13/00

(52) U.S. Cl. 492/38; 384/116

(57) ABSTRACT

A controlled deflection roll having a rotatable roll shell which is penetrated by a stationary shaft, a hydraulic bearing arrangement between shaft and roll shell, which is formed by individual hydrostatic bearing elements arranged axially beside one another, which each comprise a radially movable force element having an outer bearing pocket element, the outer bearing pocket element having a cylindrical outer bearing surface supporting the cylindrical roll shell hydrostatically on an inner shell circumferential line, and having an edge bearing unit provided at each end of the roll shell, the outer bearing pocket element (9) in each case being mounted hydrostatically on a spherical inner bearing surface (13) running concentrically with respect to the inner circumferential line of the roll shell (2).

The invention relates to a controlled deflection roll having a rotatable roll shell which is penetrated by a stationary shaft, according to the preamble of patent claim 1.

Controlled deflection rolls of this type, as described in U.S. Pat. No. 3,802,044, comprise a stationary shaft and a tubular roll shell which can be rotated about the latter, encloses an annular chamber and is supported with a hydraulic contact force on sliding surfaces of piston-like supporting elements. The known controlled deflection rolls of this type are used for many applications, for example calenders, smoothing units, press sections, printing presses, rolling mills and the like. They are used there to correct undesired deflections and deformations of the roll shell, for setting linear loads in a nip and, if appropriate, for setting a roll shell displacement with respect to the shaft in order to close nips.

During operation, the roll shell rotates around the shaft mounted so as to be fixed against rotation. Deflections arising from loading of the roll shell necessitated by the operation are absorbed by hydrostatic mountings, which are arranged on piston-like supporting elements. These support the roll shell from the inside with respect to the support. As a result, it is possible for elastic deflection of the shaft to occur. The force elements which can be extended radially from the shaft are normally designed in the manner of pistons and can be actuated by a pressure medium and which have sliding surfaces with means for hydrostatic mounting, bridge the difference in the deflection between the shaft and the inner circumference of the roll shell. In this way, support for the roll shell on the sliding surfaces of the mountings is obtained.

On account of the deflection of the shaft caused by the operational loadings of the roll, forced skewing of the hydraulic cylinders accommodating the supporting pistons, and increased loading of the supporting piston seals occurs. When the supporting pistons are extended from their hydraulic cylinders, the supporting length increases. Therefore, the instability of the supporting pistons in their supporting position is intensified. As a result, defined supporting of the roll shell becomes impossible. This is because each supporting piston is mounted in a statically undetermined manner in the supporting position because of its construction, that is to say is unstable in the supporting position. Under the influence of the operating load and the tangential forces which arise on account of the pressure fluid friction in the supporting gap with respect to the roll shell, forces act on the supporting piston and cause tilting moments in the rotational direction. In addition, as a result of the load-induced deformations and displacements of the roll shell, the production of tilting moments on the supporting pistons is promoted.

The increasing machine speeds necessitated by economic demands lead to a considerable increase in the friction in the supporting gap and, as a result, also in the friction-induced tangential forces. These conditions in turn cause an increase in the tilting moments. The tilting of the supporting pistons leads to metallic contact between the sliding surfaces of the mountings and the inner wall of the roll shell and gives rise to an increased consumption of pressure medium. As a result of the skewed positioning of the supporting pistons, the piston seals ultimately also suffer. The roll is therefore susceptible to faults and is subjected to increased wear.

It is therefore an object of the invention to provide a controlled deflection roll according to the preamble of patent claim 1 whose hydrostatic bearing elements act on the roll shell with little wear and in a securely positioned manner.

This object is achieved by the features of the characterizing part of patent claim 1.

This provides a controlled deflection roll in which the roll shell is borne by hydrostatic bearing elements which are arranged axially beside one another and are formed as hydrostatic double mountings. In this way, the roll shell is no longer supported along a pressure zone but borne on spherical inner bearing surfaces. Tilting is ruled out. A roll shell mounting of this type permits low-wear and energy-saving operation in all operating states, in particular at high speeds and under high thermal loadings and in the event of the occurrence of disruptive forces which act on the roll.

As a result of the spherical inner bearing surface, which is concentric with the roll shell circumferential line, tilting of an outer bearing pocket element and therefore any changes in the parallelism of its sealing surfaces with respect to an inner wall of the roll shell can be ruled out. All the positional changes acting on the hydrostatic bearing elements are compensated for by the outer bearing pocket elements sliding on the concentrically spherical inner bearing surfaces of the hydrostatic bearing elements, to be specific automatically. The hydrostatic double supporting therefore has the effect that the parallelism of the sealing gap of the outer bearing pocket elements with respect to the inner wall of the roll shell is always maintained, since the outer bearing pocket element slides on the inner bearing surface if the force element no longer acts centrally in the loading plane, in order itself to remain centrally in the loading plane. Consequently, the height of the sealing gap of the outer bearing pocket elements can be reduced and the consumption of pressure medium can be lowered. Such a bearing system also has a stabilizing effect and permits low-wear operation, which also saves pressure medium and energy, in all operating states, in particular at high speeds and under high thermal loadings and in the event of the occurrence of disruptive forces which act on the roll.

A deflection of the shaft which occurs under operating load can be compensated for by an equalization of the spacing resulting from the ability of the hydrostatic bearing elements arranged axially beside one another to move radially, but the outer bearing pocket element remaining immovably constantly in its supporting position and being kept radially concentric with respect to the shell circumferential line on the inner wall of the roll shell. This follows from the hydrostatic supporting of the outer hydrostatic supporting element on the spherical inner bearing surface. The inner bearing surface and the outer bearing pocket element have spherical operating surfaces for this purpose, between which a lubricant is forced. The spherical inner bearing surface permits tilting of the force elements about their longitudinal axis, along which the supporting can be guided to permit radial displacement in the shaft.

The circumferential forces which arise during the rotation of the roll shell as a result of the gap flow and as a result of the surrounding medium in the interspace of support and inner wall of the roll shell have no influence here on the statically determined position of the hydrostatic bearing device. During the operation-induced deformations of the shaft, an inner hydrostatic supporting permits the outer hydrostatic supporting element to slide without friction on a spherical inner bearing surface. The gap flow can be regulated as a result, for example with a minimum gap height.

Such a hydrostatic double supporting with a spherical inner bearing surface ensures the functional serviceability, the operational reliability and the protection of the supporting during use to a substantial extent. Furthermore, in all operating states with loads which often change rapidly, the gap lubrication is ensured. The actual maintenance of identical gap heights over the entire circumference of a sealing surface of an outer bearing pocket element results in ensuring a level of support for the roll shell which has previously not been achieved.

Furthermore, satisfactory damping of the oscillation and vibration phenomena is the direct result of the two-stage hydrostatic supporting since, with a controlled gap flow, effective damping of all the operation-induced vibrations is achieved. The roll is therefore designed for extremely high speeds and temperatures.

The hydrostatic components can each be supplied with a constant volume flow of a hydraulic pressure medium. An inner bearing pocket element which is preferably provided for the geometrically accurate holding and positioning of the outer bearing pocket element can also be supplied by a pressure-regulated flow of hydraulic pressure medium.

The regulation of the hydrostatic bearing elements is simple. A closed control loop can be used, in which in each case the two hydrostatically formed layers of the pressure medium on the supporting elements of each hydrostatic bearing element remain in an equilibrium state. Merely monitoring for faults can then be sufficient.

The hydrostatic supporting, in addition to its great functional advantages, is additionally surprisingly simple in its design construction and does not require any new solutions for components otherwise to be provided in the bearing region.

The hydrostatic bearing elements according to the invention can also be used as edge bearings and, for this purpose, are either arranged on a radially displaceable bearing ring or fixed to the support. In this case, at least two force elements are arranged to be distributed circumferentially.

For a low-fault and effective axial mounting of the roll shell, it is possible to fall back on known solutions.

Further refinements and advantages of the invention can be gathered from the dependent claims and the following description.

The invention will be explained in more detail below using the exemplary embodiments illustrated in the appended figures.

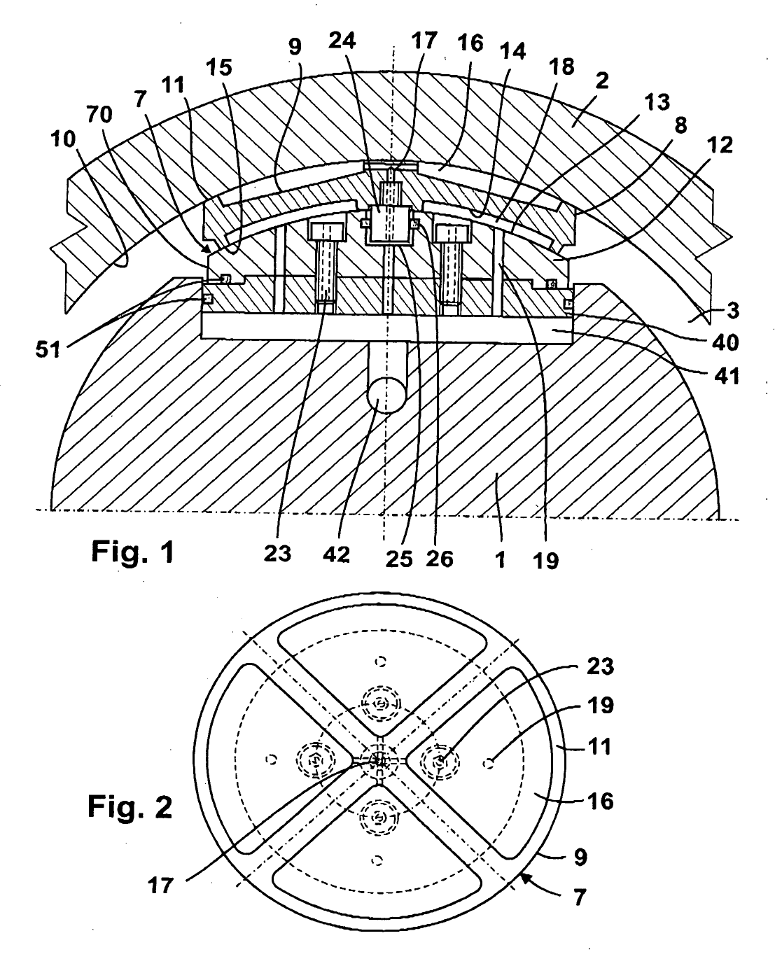

FIG. 1 shows in schematic form a partial cross section of a roll according to a first exemplary embodiment,

FIG. 2 shows in schematic form a plan view of a hydrostatic bearing element of the roll according to FIG. 1,

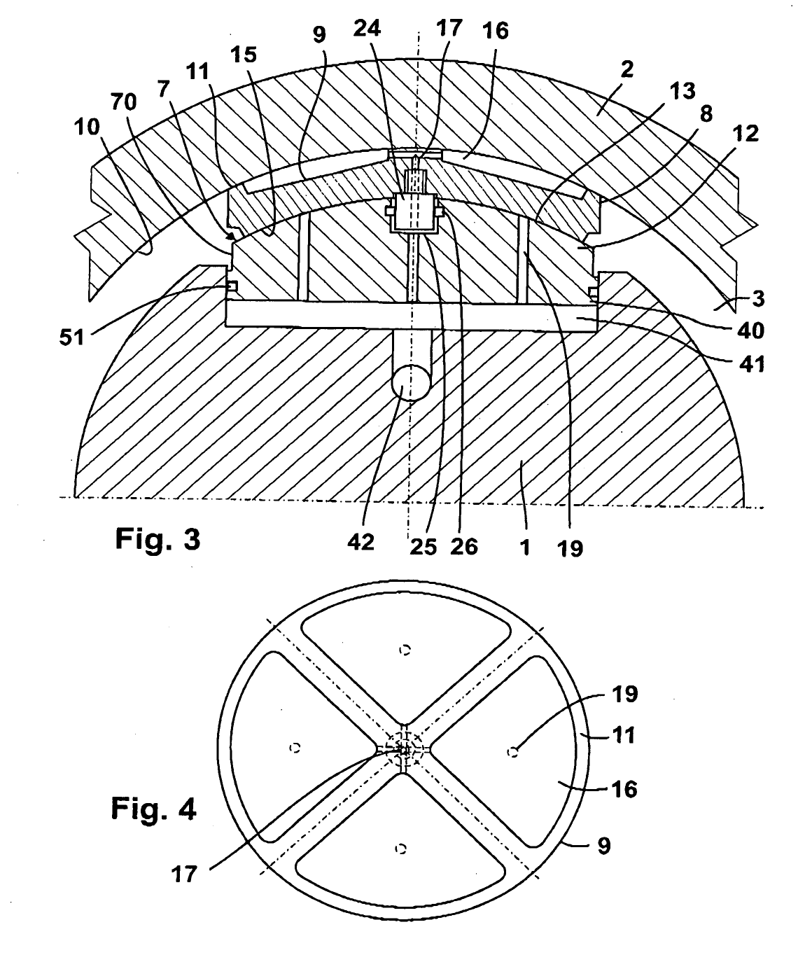

FIG. 3 shows in schematic form a partial cross section of a roll according to a second exemplary embodiment,

FIG. 4 shows in schematic form a plan view of a hydrostatic mounting of the roll according to FIG. 3,

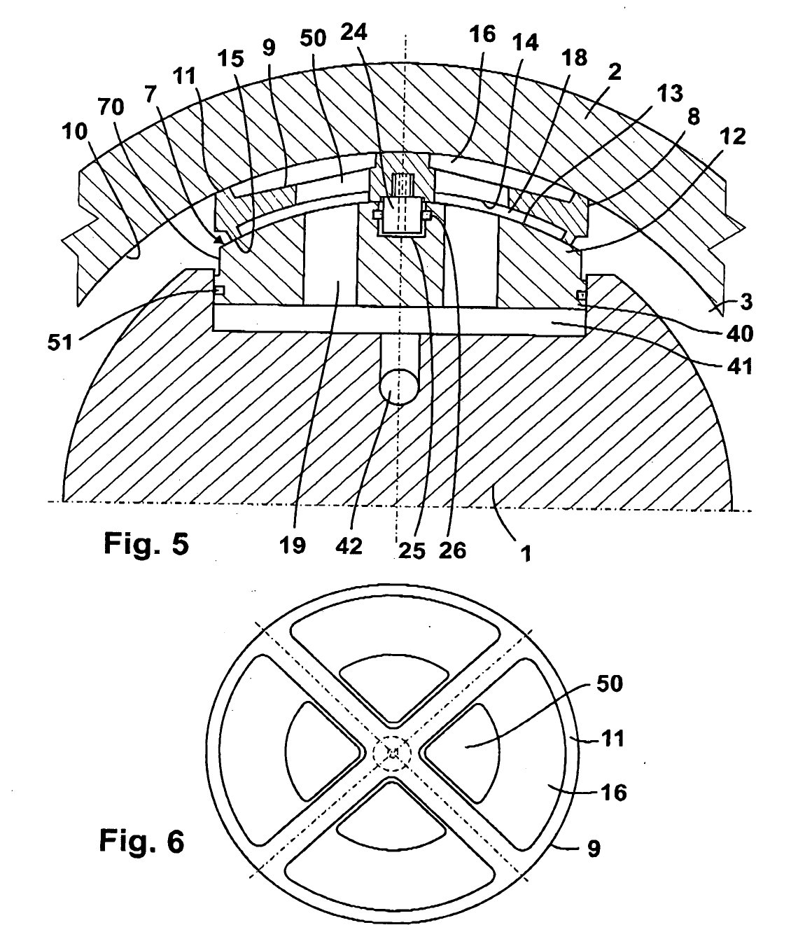

FIG. 5 shows in schematic form a partial cross section of a roll according to a third exemplary embodiment,

FIG. 6 shows in schematic form a plan view of a hydrostatic mounting of the roll according to FIG. 5,

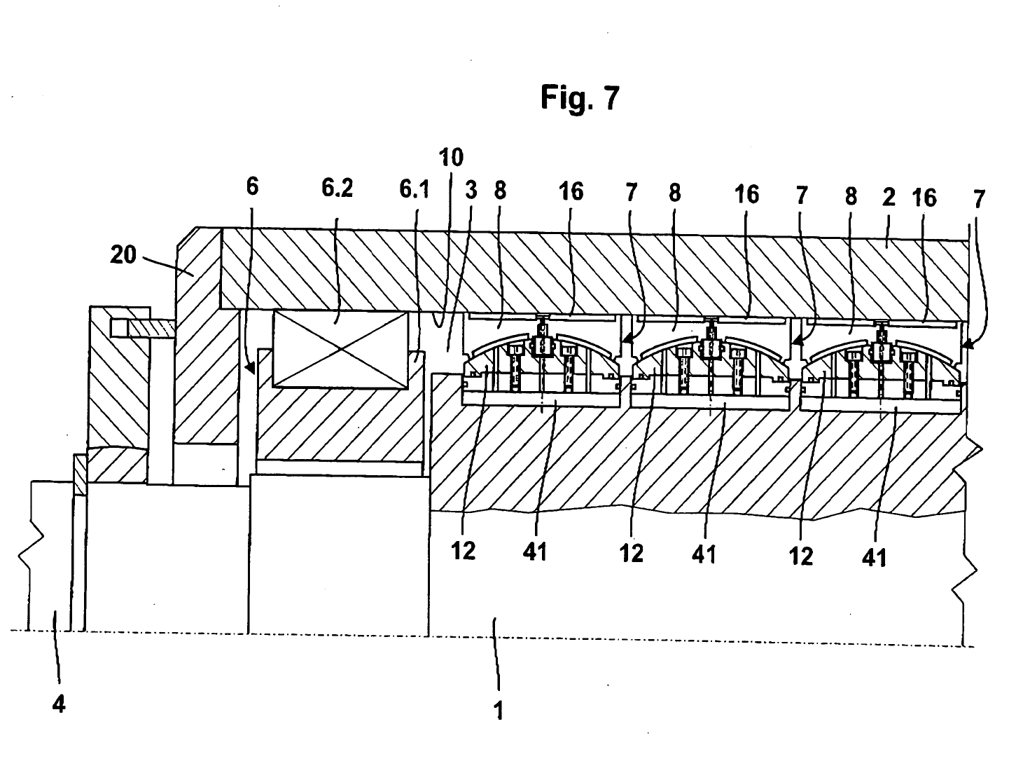

FIG. 7 shows in schematic form a partial longitudinal section of a roll according to the first exemplary embodiment,

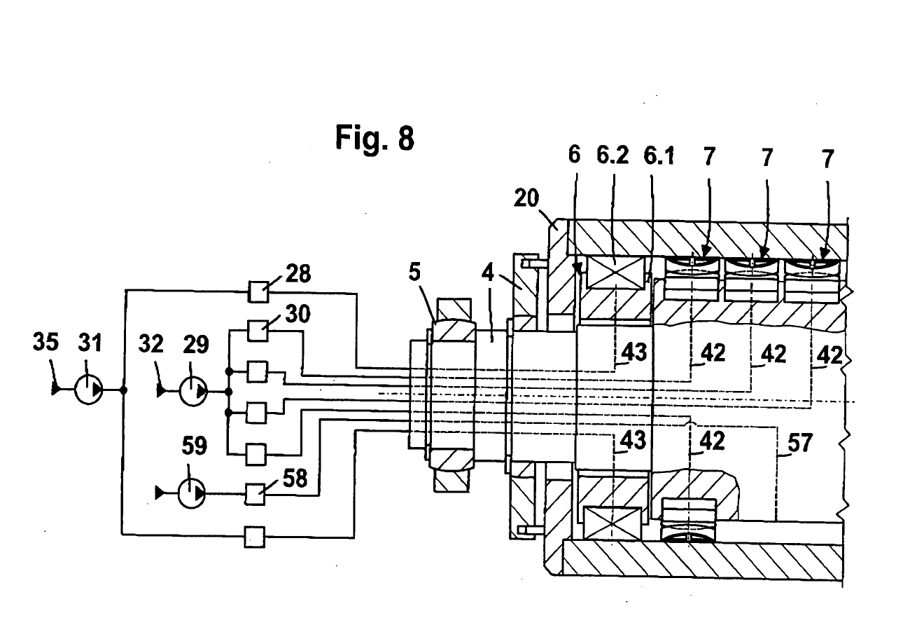

FIG. 8 shows in schematic form a partial longitudinal section of a roll according to the first exemplary embodiment with associated hydraulic system,

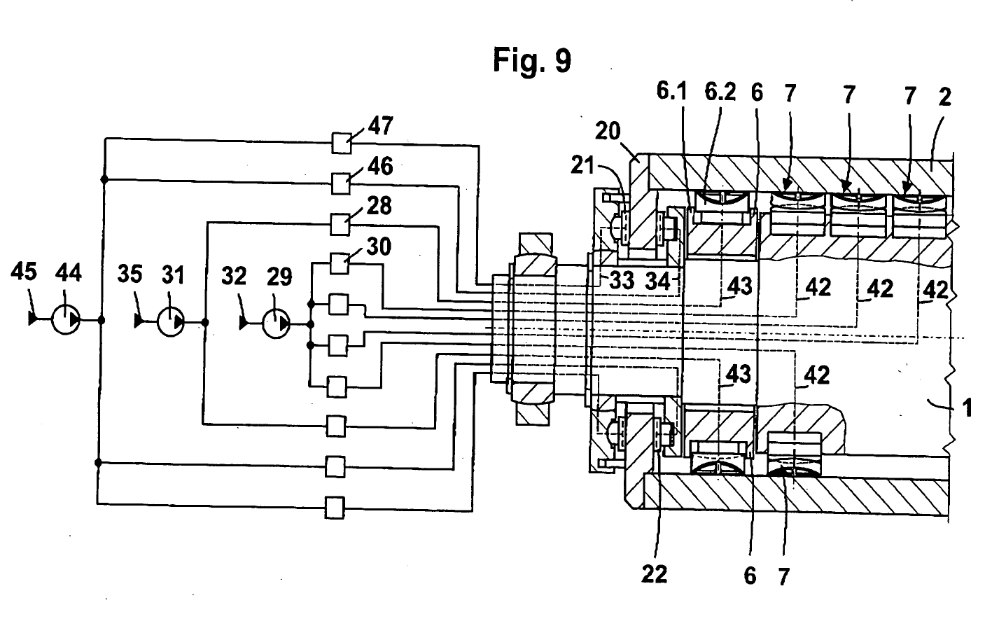

FIG. 9 shows in schematic form a partial longitudinal section of a roll according to the fourth exemplary embodiment with associated hydraulic system.

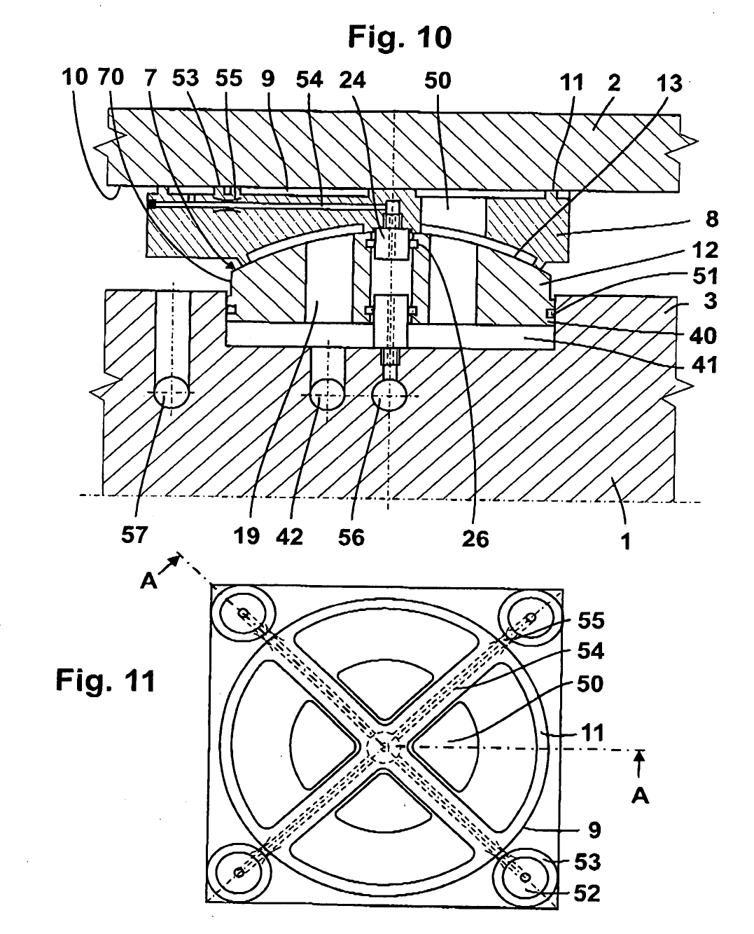

FIG. 10 shows in schematic form a partial longitudinal section, along A-A in FIG. 11, of a hydrostatic bearing element according to a fifth exemplary embodiment,

FIG. 11 shows in schematic form a plan view of a hydrostatic bearing element of a roll according to the fifth exemplary embodiment.

The invention relates to a controlled deflection roll for forming a nip in an apparatus, preferably in a calender or press for the treatment of a product web, in particular a paper web or board web.

According to a first exemplary embodiment of the invention, illustrated in FIGS. 1, 2, 7 and 8, the controlled deflection roll has a roll shell 2 which is penetrated by a shaft 1 that is fixed against rotation. The roll shell 2 is formed as a roll tube or roll shell, that is to say the roll shell 2 surrounds an annular space 3 in which the shaft 1 is arranged. The shaft 1 is held with its ends 4 (FIG. 8) in a spherical bearing 5 in each case so as to be fixed against rotation but pivotable. The roll shell 2 can be rotated with respect to the shaft 1 and is supported at both ends by an edge bearing unit 6 in each case. Depending on the use of the roll, the roll shell 2 can either be displaceable relative to the shaft 1 or can be supported directly on the shaft 1 by means of an edge bearing. The edge bearing unit 6 here preferably comprises, according to FIGS. 7, 8 and 9, a bearing ring 6.1 which can be displaced radially with respect to the shaft 1 and has a bearing 6.2 which, for example, is formed by an antifriction bearing. As a result, the roll shell 2 can be positioned in various positions with respect to the shaft 1. The antifriction bearing used is preferably a self-aligning roller bearing, which has the two functions of the radial and also of the axial bearing. As a result, the position of the roll shell 2 with respect to the shaft 1 is also ensured in the axial direction.

In an alternative embodiment of the bearing 6.2 as a hydrostatic bearing, the axial mounting of the roll shell 2 with respect to the shaft 1 can likewise be carried out by means of a hydrostatic axial bearing. For this purpose, the roll shell 2 preferably has a side wall 20 at least at one end, which secure the axial position of the roll shell 2 in relation to the shaft by means of hydrostatic axial bearings 21, 22 (cf. FIG. 9)

Arranged between the shaft 1 and the roll shell 2 is a hydraulic bearing arrangement for supporting the roll shell 2 along at least one active region which is formed by individual radially movable hydrostatic bearing elements 7 arranged axially beside one another, to each of which a pressure medium can be supplied at an adjustable pressure. The bearing elements 7 are provided to transmit pressure between roll shell 2 and shaft 1, the pressure medium being used for contact pressure and hydrostatics, specifically with a common or a separate supply, depending on the design of the hydrostatic bearing element 7.

The bearing elements 7 are arranged in an active plane along opposite active regions (cf. FIG. 8) according to the first exemplary embodiment, an active region extending along the roll between the two edge bearing units 6 in each case and comprising a bearing element 7 or a plurality of bearing elements 7 arranged distributed axially in a row. Alternatively, only at least one active region is provided or a plurality of active regions are arranged distributed circumferentially.

As FIG. 1 shows, each bearing element 7 comprises a force element 70 having an outer bearing pocket element 9. The force element 70 can be moved radially hydraulically in order to transmit a contact pressure to an inner circumference 10 or an inner wall of the roll shell 2, which means that the roll shell 2 can be forced radially outward. The outer bearing pocket element 9 has a cylindrical outer bearing surface supporting the cylindrical roll shell 2 hydrostatically on the inner shell circumferential line 10 and having a circumferential outer bearing inner surface 11. The outer bearing pocket element 9 is borne and guided by the force element 70, to which end the outer bearing pocket element 9 is mounted hydrostatically on a spherical inner bearing surface 13 running concentrically with respect to the inner circumferential line 10 of the roll shell 2.

The outer bearing pocket element 9 is formed here on an outer hydrostatic supporting element 8 and has at least one, preferably four, pressure pockets 16 (cf. FIG. 2), which are supplied with a pressure medium for hydrostatics via a common feed line 17, which branches into the pressure pockets 16. As a result of pressurizing the outer bearing pocket element 9 with pressure medium, a flow gap is formed between the outer bearing edge surface 11 and the shell inner wall 10 of the roll shell 2, which produces an outer hydrostatic sliding bearing. The form and number of pressure pockets 6 can be chosen individually. The hydrostatic supporting element B has, on the side opposite the outer bearing pocket element 9, an outer bearing inner surface formed in the manner of a segment of a shell and having a circumferential inner bearing edge surface 15, which is formed as a spherical operating surface for a hydrostatic bearing with the spherical inner bearing surface 13, which means that the outer bearing pocket element 9 is mounted hydrostatically on the inner bearing surface 13. As a result, the outer bearing pocket element 9 experiences a supporting function, since the hydrostatic operating surfaces are supported on one another by sliding and therefore have the effect of a surface support and not a point support.

For the hydrostatic supporting of the outer bearing pocket element 9 on the inner bearing surface 13, an inner bearing pocket element 14 is preferably provided. The inner bearing pocket element 14 is formed on the outer hydrostatic supporting element 8, according to the first exemplary embodiment of the roll illustrated in FIG. 1. The inner bearing pocket element 14 has at least one pressure pocket 18, which is supplied with a pressure medium via a feed line 19. Since the inner bearing pocket element 14 with its at least one pressure pocket 18 is integrated into the outer hydrostatic supporting element 8, an outer bearing inner surface having pressure pockets and an inner bearing edge surface 15 are formed on the outer hydrostatic supporting element 8 and are borne by the spherical inner bearing surface 13, forming a sealing gap. As a result of pressurizing the inner bearing pocket element 14 with a pressure medium, a flow gap is formed between the inner bearing edge surface 15 of the outer hydrostatic supporting element 8 and the inner bearing surface 13, which means that an inner hydrostatic bearing is produced, comprising a spherical inner bearing surface 13 and associated outer bearing inner surface shaped in the manner of a segment of a shell and having an inner bearing edge surface 15.

The spherical inner bearing surface 13 is provided on an inner hydrostatic supporting element 12 of a force element 70. The inner hydrostatic supporting element 12 can be fixed to a piston section 40 of the force element 70, for example by means of screws 23, or formed in one piece with the former. The inner hydrostatic supporting element 12 has an upper side that faces the outer hydrostatic supporting element 8 and forms the spherical inner bearing surface 13. The spherical design is such that the inner bearing surface 13 runs concentrically with respect to the inner roll shell circumferential line 10. The same is true of the outer bearing inner surface shaped in the manner of a segment of a shell and having a circumferential inner bearing edge surface 15 which, as a spherical operating surface, interacts with the spherical inner bearing surface 13.

According to an alternative embodiment of the invention, not illustrated, the inner bearing pocket element 14 can also be formed on the inner hydrostatic supporting element 12, so that the spherical inner bearing surface 13 is then formed with pressure pockets, while the outer bearing inner surface 15 can be a shell surface without pressure pockets.

The force element 70 is preferably formed as a pressure piston having a piston section 40 which is radially guided such that it can be displaced in a cylindrical recess 41 in the support 1 in order to form a hydraulic piston-cylinder unit. For this purpose, the recess 41 can be pressurized with a pressure medium, for example oil, via a line 42. Sealing with respect to the annular space 3 can be provided by means of seals 51. The pressure medium can be used for the contact force and the hydrostatics. Pressure medium flows through the line 42 into the pressure chamber, that is to say the recess 41, of the force element 7. The pressure medium flows out of the pressure chamber firstly through the feed lines 19 into the inner bearing pocket element 14 and secondly through the feed line 17 into the outer bearing pocket element 9. The effective pressure transmission surface of the pressure chamber of the piston section 40, the effective pressure transmission surface between the outer bearing pocket element 9 and roll shell 2, the effective pressure transmission surface between the inner bearing pocket element 14 and inner bearing surfaces 13, and a throttling action of the lines 17, 19 are coordinated with one another in such a way that the outer bearing pocket element 9 remains positioned centrally in relation to the roll shell inner circumference 10 if the piston section 40 with the inner supporting element 12 tilts. The outer hydrostatic supporting element 8 accordingly remains tied to the inner circumferential line 10 such that it can slide in the axial direction and radial direction.

The feed line 17 for a pressure medium to the outer bearing pocket element 9 is preferably provided by means of a sealing pin 24, which is fixed in the outer hydrostatic supporting element 8, for example screwed in, and at its other end is sealed in a cylindrical countersink 25 in the inner hydrostatic supporting element 12 via insert pieces, preferably seals 26 made of a resilient material. This prevents the emergence of the pressure medium outside the feed line 17. The insert pieces are dimensioned such that they ensure automatic concentric displacement of the outer bearing pocket element 9 of the outer hydrostatic supporting element 8 with respect to the inner bearing surface 13, and on the other hand position the outer hydrostatic supporting element 8 with respect to the inner hydrostatic supporting element 12. The displacement of the outer hydrostatic supporting element 8 with respect to the inner hydrostatic supporting element 12 takes place on the concentric spherical inner surface 13, so that the supporting position of the outer bearing pocket element remains central. The mechanical positioning aid by means of sealing pins 24 defines the limits of the displaceability of the outer supporting element 8 with respect to the inner supporting element 12.

The feed lines 17, 19, 42 for the pressure medium to the outer bearing pocket element 9, inner bearing pocket element 14 and the cylindrical recess 41 can in each case be connected in a known way to a pressure medium reservoir. The connection to a pressure medium reservoir can in each case be carried out via a control unit, which determines the pressure and the flow of the pressure medium. It is preferable for the outer and inner bearing pocket elements 9, 14 to be capable of pressurization with a constant volume flow of the hydraulic medium in each case. The inner bearing pocket element 14 can also be supplied with pressure medium via a controlled pressure flow for the purpose of the geometrically accurate holding and positioning of the outer bearing pocket element 9.

FIG. 8 shows the deflection controlled roll according to the first exemplary embodiment with associated hydraulic system. A pump 29 is provided, which delivers pressure medium from a reservoir 32. It delivers the pressure medium via regulators 30 to the pressure lines 42 of the mountings 7.

A further pump 31, which delivers from the reservoir 35, is advantageously provided for the supply of the edge bearings 6, the volume flow of the pressure medium passing via regulators 28 to the lines 43 of the edge bearings 6.

The annular space 3 of the roll can be pressurized via a line 57 with a pressure medium in order to be able to set an internal pressure in the annular space 3 with respect to the bearing elements 7. For this purpose, a pump 59 delivers pressure medium via a regulator 58 and the line 57 into the annular space 3.

Furthermore, the controlled deflection roll can be designed to be heatable, for which purpose pressure medium is used simultaneously as a heating medium. The roll can be used as a hard roll or the roll shell 2 can have an outer resilient cover in order to form a soft roll.

Alternatively, according to the exemplary embodiment illustrated in FIG. 9, the edge bearing 6 can be formed by hydrostatic mountings, which correspond to the mountings 7 described above, that is to say are structurally identical. Preferably, at least two bearing elements of the type described are in each case arranged distributed circumferentially at each end of the roll shell. The hydraulic system corresponds to that described above.

Hydraulic feed lines 33, 34 can lead to axial bearings 21, 22 in order to form the latter as hydrostatic bearings. The axial bearings 21, 22 can also be designed for axial displaceability of the roll shell 2. A further pump 44, which delivers from a reservoir 45, is advantageously provided for the supply of axial bearings 21, 22, the volume flow of the pressure medium passing via regulators 46, 47 to feed lines 33, 34 of the axial bearings 21, 22. This ensures the axial mounting of the roll shell 2 with respect to the support 1.

FIGS. 3 and 4 show a second exemplary embodiment of a roll, which differs from the first exemplary embodiment described previously in that inner bearing pockets 14 are not formed. The outer bearing inner surface 15 forms a shell surface, which is mounted hydrostatically as a sliding surface on the spherical inner bearing surface 13. Hydraulic pressure medium can be fed between the outer bearing inner surface and the inner bearing surface 13 via supply lines 19. Furthermore, the inner hydrostatic supporting element 12 is formed in one piece with a piston section 40 of the force element 70. Otherwise, the above explanations in relation to the first exemplary embodiment apply in a corresponding manner here.

FIGS. 5 and 6 show a third exemplary embodiment of a deflection controlled roll, which differs from the first exemplary embodiment in that the effective pressure for the contact force of the mountings 7 is present unthrottled on the roll shell 2. Therefore, a column of pressure medium acts between the support 1 and roll shell 2 via the passages 19, 50 in the supporting elements 12, 8. The throttling action is performed here by gaps formed between the inner bearing edge surface 15 and the inner bearing surface 13, on the one hand, and the outer bearing edge surface 11 and the roll shell inner wall 10, on the other hand. Furthermore, the inner hydrostatic supporting element 12 here is also formed in one piece with a piston section of the force element 70. Otherwise, the above explanations apply in a corresponding manner.

According to a development of the invention according to a fifth exemplary embodiment, illustrated in FIGS. 10 and 11, an outer hydrostatic supporting element 8 is in each case assigned a sealing gap maintaining apparatus. The sealing gap maintaining apparatus comprises a hydrostatic bearing element which has an independent pressure medium supply, which is separated from the pressure medium column for the contact force and operates independently of the latter. For this external pressure of the independent pressure medium supply, a pressure medium feed 56 is provided which feeds the mounting element. The hydrostatic bearing element is preferably formed outside the outer bearing edge surface 11 on the outer hydrostatic supporting element 8 and comprises at least three bearing pockets 52 with edge surfaces 53 arranged distributed circumferentially. The bearing pockets 52 are connected to pressure medium lines 54 having incorporated throttles 55 and are fed jointly via connected pressure medium lines 54. At the bearing pockets 52, by means of their pressure medium supply, flow gaps are formed over the edge surfaces 53 with respect to the roll shell 2, which ensure that the outer bearing edge surface 11 is spaced apart from the roll shell inner wall 10. For example, four bearing pockets 52 arranged distributed circumferentially are provided here.

This achieves the situation in which, if the sealing gap between outer bearing inner surface 11 and the roll shell inner wall 10 of the roll shell 2 does not receive any pressure medium flow from the pressure column acting for the contact force, an auxiliary hydrostatic supporting becomes effective. The sealing gap maintaining element consequently maintains a sealing gap over the outer bearing inner surface 11 even if the force elements 70 are relieved of load. As a result, any contact with the inner wall surface 10 of the roll shell 2 is ruled out.

However, the sealing gap maintaining element also acts if an internal pressure which can be set in the annular space 3 of the roll is higher than a contact pressure on the force element 70, for example as a result of lowering the contact pressure, so that a depression is formed on the force element 70. The flow gap over the edge surfaces 53 of the sealing gap maintaining element can, however, also be maintained by means of the external pressure medium feed 56 to the bearing pockets 52, which means that the sealing gap over the outer bearing edge surface 11 is maintained. The pressure medium from the annular space 3 can flow through this sealing gap into the depression, with the consequence that, while maintaining an outer bearing edge surface 11 mounted hydrostatically on the roll shell 2, a force directed toward the support 1 acts on the roll shell 2. This permits a local reduction in a line force exerted by the roll on a mating roll, not illustrated.

The sealing gap maintaining elements of the individual bearing elements 7 can be connected to a common pressure medium feed 56.

1-18. (canceled)

19. A controlled deflection roll having a rotatable roll shell which is penetrated by a stationary shaft, a hydraulic bearing arrangement between shaft and roll shell, which is formed by individual hydrostatic bearing elements arranged axially beside one another, which each comprise a radially movable force element having an outer bearing pocket element, the outer bearing pocket element having a cylindrical outer bearing surface supporting the cylindrical roll shell hydrostatically on an inner shell circumferential line, and having an edge bearing unit provided at each end of the roll shell, the outer bearing pocket element in each case being mounted hydrostatically on a spherical inner bearing surface running concentrically with respect to the inner circumferential line of the roll shell.

20. The controlled deflection roll as claimed in claim 1, the hydrostatic bearing elements in each case having an inner hydrostatic supporting element, on which the inner bearing surface is formed.

21. The controlled deflection roll as claimed in claim 1, the force element being formed as a pressure piston, which is guided such that it can be moved radially in a recess in the shaft.

22. The controlled deflection roll as claimed in claim 1, the inner bearing surface being assigned an inner bearing pocket element.

23. The controlled deflection roll as claimed in claim 1, the outer bearing pocket element being formed by an outer hydrostatic supporting element, which accommodates an inner bearing pocket element while forming an inner bearing edge surface.

24. The controlled deflection roll as claimed in claim 1, the spherical inner bearing surface being provided on an inner supporting element of a force element.

25. The controlled deflection roll as claimed in claim 1, the inner bearing surface consisting of individual surface sections.

26. The controlled deflection roll as claimed in claim 1, the hydrostatic bearing elements each being connected to a feed line for a pressure fluid for feeding bearing pocket elements.

27. The controlled deflection roll as claimed in claim 26, the feed lines for the pressure fluid each being connected to a control unit which determines the pressure and the flow of the pressure fluid.

28. The controlled deflection roll as claimed in claim 26, it being possible for outer and inner bearing pocket elements to be pressurized with a constant volume flow of a pressure fluid in each case.

29. The controlled deflection roll as claimed in claim 1, the edge bearing unit at the end of the roll shell being formed by an antifriction bearing arranged on a radially moveable bearing ring in each case.

30. The controlled deflection roll as claimed in claim 1, the edge bearing unit at the end of the roll shell being formed by at least two hydraulic bearings arranged distributed in the circumferential direction on a radially movable bearing ring, which are formed in the same way as the hydrostatic bearing elements.

31. The controlled deflection roll as claimed in claim 1, the hydrostatic bearing elements being arranged along opposite rows between the two edge bearing units.

32. The controlled deflection roll as claimed in claim 1, it being possible for a heating medium to be fed into an annular space between roll shell and shaft.

33. The controlled deflection roll as claimed in claim 1, the roll shell having an outer resilient cover.

34. The controlled deflection roll as claimed in claim 1, the outer hydrostatic supporting element in each case being assigned a sealing gap maintaining apparatus, which comprises a hydrostatic mounting element with an independent pressure medium supply.

35. The controlled deflection roll as claimed in claim 34, the hydrostatic bearing element being formed outside the outer bearing edge surface on the outer hydrostatic supporting element and comprising at least three bearing pockets arranged distributed circumferentially and fed jointly via connected pressure lines.

36. The controlled deflection roll as claimed in claim 34, the hydrostatic bearing element having a plurality of bearing pockets arranged at a distance from one another and bounded by an annular surface in each case.
